(19) United States
(12) Patent Application Publication
(10) Pub. No.: US 2025/0136407 A1
(43) Pub. Date: May 1, 2025

(54) METHOD FOR COLLABORATIVELY CONTROLLING MULTI-CHANNEL BRAKING SYSTEM OF MINE HOIST

(71) Applicant: China University of Mining and Technology, Jiangsu (CN)

(72) Inventors: Yu TANG, Jiangsu (CN); Zhencai ZHU, Jiangsu (CN); Gang SHEN, Jiangsu (CN); Hao LU, Jiangsu (CN); Yuxing PENG, Jiangsu (CN); Gongbo ZHOU, Jiangsu (CN); Hui XIE, Jiangsu (CN); Wei WANG, Jiangsu (CN); Deen BAI, Jiangsu (CN); Qingguo WANG, Jiangsu (CN)

(73) Assignee: China University of Mining and Technology, Jiangsu (CN)

(21) Appl. No.: 18/690,743

(22) PCT Filed: Aug. 3, 2023
(86) PCT No.: PCT/CN2023/110982

§ 371 Date: Mar. 11, 2024

(30) Foreign Application Priority Data
Sep. 15, 2022 (CN) 202211122933.9

(51) Int. Cl. B66B 1/36; B66B 5/02; F16D 66/00; F16D 66/02; F16D 121/02

(52) U.S. Cl. CPC B66B 1/365; B66B 5/02; F16D 66/026; F16D 2066/003; F16D 2066/005; F16D 2121/02

(57) ABSTRACT

The present disclosure discloses a method for collaboratively controlling a multi-channel braking system of a mine hoist, including obtaining the abrasion loss of the brake shoe by detecting position information of the brake shoe of each of disc brakes in real time, dividing abrasion loss levels by determining different abrasion degrees of the brake shoe, formulating three braking force distributing modes: an average distribution, a proportional distribution, and an index distribution according to the abrasion loss levels, thereby dynamically adjusting a set braking pressure of each of the disc brakes, tracking and controlling the set braking pressure through the disc brakes by adopting a pressure closed-loop control method by utilizing a pressure signal feedback from an oil pressure sensor, implementing a collaborative braking control of the multi-channel braking system of the mine hoist based on the abrasion loss of the brake shoe.

### TECHNICAL FIELD

The present disclosure relates to the technical field of mine hoist, and specifically relates to a method for collaboratively controlling a multi-channel braking system of a mine hoist.

### RELATED ART

As key equipment responsible for tasks such as lifting materials and equipment, elevating personnel in coal productions, the safety and the reliability of the mine hoist not only directly affect the productions and economic benefits of the entire mine, but most importantly are related to the life safety of the miners. As the most critical safety guarantee equipment of the hoist, the braking device has an extremely important impacts on mineral productions and the life safety of the miners in terms of its operational safety. With the increasing requirements for the transportation capacity and the safety of the mine hoist, researchers develop a multi-channel braking system to enhance the safety of the braking process of the mine hoist. A constant deceleration braking of the hoist is implemented by each of the independent disc brakes according to the same deceleration command signals and the same speed feedback signals. In this way, each of the disc brakes obtains the same braking force given signal, which is driven by a separate proportional directional valve to complete the braking force tracking control. Theoretically, each of the disc brakes maintains the same braking pressure during the braking process. However, due to the factors such as differences on hydraulic pipeline layouts, brake installation errors, and directional valve pressure flow characteristics, and differences on response characteristics of the disc brakes, the issues of uneven abrasion of the brake shoes will be inevitably caused. Applying the same set braking pressure to each of the disc brakes currently leads to a phenomenon of increased abrasion of the single or a plurality of brake shoes of the disc brakes, resulting in issues such as a decreased braking performance, a reduced service life, and even braking failures, which not only affects the production efficiency, but also brings significant risks to braking safety.

### SUMMARY OF INVENTION

The objectives of the present disclosure are to provide a method for collaboratively controlling a multi-channel braking system of a mine hoist, which is capable of implementing dynamic distributions of the braking force, ensuring a consistency in abrasion of multiple brake shoes of the disc brakes, solving the issues of uneven abrasions of the brake shoes, and thereby improving the safety of the mine hoist operations.

### Solution to Problem

In order to realize the above objectives, the present disclosure provides a method for collaboratively controlling a multi-channel braking system of a mine hoist. The control method is based on a multi-channel braking system and the multi-channel braking system includes a plurality of disc brakes. Each of the disc brakes is controlled by an independent proportional control valve, and an oil pressure sensor and a displacement sensor are arranged on each of the disc brakes. And the control method includes the following steps.

In Step S1, initial position information xᵢₛ₀ and x_{iy0} of a brake shoe as well as an initial thickness Δᵢ₀ of the brake shoe in the case where each of the disc brakes is completely released and compressed, are measured by utilizing a displacement sensor respectively, where i denotes an i_th disc brake.

In Step S2, a position xᵢₛ of the brake shoe when the disc brake is completely released is recorded by utilizing the displacement sensor before the braking command is issued, and a position x_{iy} of the brake shoe when the disc brake is fully compressed is recorded by utilizing the displacement sensor after the braking command is issued, in the case where a hoist system is officially put into use.

In Step S3, an abrasion loss Δᵢ of the brake shoe, and a total abrasion loss Δₛᵤₘ=Σᵢ₌₁ⁿΔᵢ of the brake shoe in the braking system are calculated according to the measured position information of the disc brake, where n denotes the number of the disc brakes and an average abrasion loss of the brake shoe is denoted as Δ_{avg}=Σᵢ₌₁ⁿΔᵢ/n, a percentage λ_{avg} of the average abrasion loss of the brake shoe relative to the total abrasion loss of the brake shoe is calculated according to the physical quantities, and a calculation formula thereof is:

$${λ}_{avg} = \frac{{Δ}_{avg}}{{Δ}_{s u m}} = \frac{1}{n} .$$

In Step S4, a percentage λᵢ of an abrasion loss of the brake shoe of the i-th disc brake relative to the total abrasion loss, and an abrasion loss rate ηᵢ of the abrasion loss of the brake shoe of the i-th disc brake relative to the total abrasion loss are calculated, and calculation formulas thereof are:

$${λ}_{i} = \frac{{Δ}_{i}}{{Δ}_{s u m}} = \frac{( {x}_{iy} - {x}_{is} ) - ( {x}_{iy 0} - {x}_{is 0} )}{{\sum }_{i = 1}^{n} {Δ}_{i}} ,$$

$${η}_{i} = \frac{{Δ}_{i}}{{Δ}_{i 0}} .$$

In Step S5, an abrasion loss degree of the brake shoe of the disc brakes is divided into three abrasion loss levels by comparing λᵢ with λ_{avg}. The abrasion loss level is classified as an abrasion loss level I in the case of λᵢ≤k₁λ_{avg}, the abrasion loss level is classified as an abrasion loss level II in the case of k₁λ_{avg}<λᵢ≤k₂λ_{avg}, and the abrasion loss level is classified as an abrasion loss level III in the case of λᵢ>k₂λ_{avg}. Three different distributing means on a total required braking force F_{ref} are executed according to different abrasion loss levels of the brake shoe of the disc brakes. And k₁ and k₂ denote coefficients for dividing the abrasion loss level of the brake shoes respectively.

In Step S6, in the case where the abrasion loss level of the brake shoe of the disc brakes is the abrasion loss level I, a total braking force Fₛᵤₘ obeys an equal distribution principle, and a braking force distribution value Fᵢ of the disc brakes is set as:

$${F}_{i} = \frac{{F}_{sum}}{n} .$$

In Step S7, in the case where the abrasion loss level of the brake shoe of the disc brakes is the abrasion loss level II, the total braking force Fₛᵤₘ obeys a proportional distribution principle, and the braking force distribution value Fᵢ of the disc brakes is set as:

$${F}_{i} = {F}_{s u m} \cdot \frac{{Δ}_{i 0} - {Δ}_{i}}{{\sum }_{i = 1}^{n} ( {Δ}_{i 0} - {Δ}_{i} )} .$$

In Step S8, in the case where the abrasion loss level of the brake shoe of the disc brakes is the abrasion loss level III, the total braking force Fₛᵤₘ obeys an index distribution principle. and the braking force distribution value Fᵢ of the disc brakes is set as:

$${F}_{i} = {F}_{s u m} \frac{{e}^{( {Δ}_{i 0} - {Δ}_{i} )}}{{\sum }_{i}^{n} {e}^{( {Δ}_{i 0} - {Δ}_{i} )}} .$$

In Step S9, a closed-loop tracking control of the disc brake for the braking force distribution value Fᵢ is implemented driven by a proportional directional valve, by utilizing a pressure signal feedback from the oil pressure sensor arranged on an oil inlet chamber of the disc brake, after completing a distribution of a braking pressure for the disc brake.

In Step S10, a braking task is completed, a dynamic distribution of the braking force is implemented, and Step S1 to Step S9 are repeated in the case of requiring a subsequent braking operation.

Further, in Step S7, whether to have a situation where the braking force distribution value Fᵢ of the disc brakes is greater than Fₘₐₓ is determined. Fₘₐₓ denotes a maximum braking force that a single disc brake is capable of supplying. it is indicated that the disc brake reaches the maximum braking force that the single disc brake is capable of supplying, that is, the braking force of the disc brake is saturated, when the braking force distribution value Fᵢ of the disc brakes is greater than Fₘₐₓ. The number m of the disc brakes that reach the saturated braking force is detected. For j disc brakes that reach the maximum braking force, a braking force distribution value is set as Fⱼ=Fₘₐₓ, j=1, . . . ,m. A remaining required braking force Fₛᵤᵣ=Fₛᵤₘ−m·Fₘₐₓ is calculated, and a braking force Fₛᵤᵣ is redistributed for n−m disc brakes that do not reach the saturated braking force, and a braking force distribution value Fᵢ of the n−m disc brakes that do not reach the saturated braking force is set as:

$${F}_{i} = {F}_{s u r} \cdot \frac{{Δ}_{i 0} - {Δ}_{i}}{{\sum }_{i = 1}^{n - m} ( {Δ}_{i 0} - {Δ}_{i} )} .$$

Further, in Step S8, whether to have a situation where the braking force distribution value Fᵢ of the disc brakes is greater than Fₘₐₓ is determined. It is indicated that the disc brake reaches the maximum braking force that the single disc brake is capable of supplying, that is, the braking force of the disc brake is saturated, when the braking force distribution value Fᵢ of the disc brakes is greater than Fₘₐₓ. The number m of the disc brakes that reach the saturated braking force is detected. For m disc brakes that reach the maximum braking force, a braking force distribution value is set as Fⱼ=Fₘₐₓ, j=1, . . . ,m. A remaining required braking force Fₛᵤᵣ=Fₛᵤₘ−m·Fₘₐₓ is calculated, and a braking force Fₛᵤᵣ is redistributed for n−m disc brakes that do not reach the saturated braking force, and a braking force distribution value Fᵢ of the n−m disc brakes that do not reach the saturated braking force is set as:

$${F}_{i} = {F}_{sur} \cdot \frac{{e}^{( {Δ}_{i 0} - {Δ}_{i} )}}{{\sum }_{i}^{n - m} {e}^{( {Δ}_{i 0} - {Δ}_{i} )}} .$$

Further, in a case where it is indicated that the brake shoe of the disc brake is failed when the abrasion loss rate ηᵢ of the brake shoe of the i-th disc brake is greater than or equal to ηₘₐₓ, the hoist is terminated for maintenance, the brake shoe is replaced, and then Step S2 is performed. And ηₘₐₓ denotes a set safety threshold for the abrasion loss rate of the brake shoe.

Further, the safety threshold ηₘₐₓ for the abrasion loss rate of the brake shoe ranges from 15% to 25%.

Further, the coefficients k1 and k2 for dividing the abrasion loss level of the brake shoes range from 1.5 to 2.5, and from 4.5 to 5.5, respectively.

Further, the proportional control valve is a three-position and four-way proportional control valve.

Further, a center position of a valve core of the three-position and four-way proportional control valve is a fully covered structure.

Further, the multi-channel braking system includes eight channels, one disc brake is arranged on each of the channels, and eight disc brakes are symmetrically distributed on both sides of a brake disc.

### Effects of Invention

The beneficial effects of the present disclosure are as follows. In the present disclosure, three abrasion loss levels are divided according to the degree of the abrasion loss by detecting the abrasion loss of the brake shoe of the each of the disc brakes; three braking force distribution strategies: an average distribution, a proportional distribution, and an index distribution are formulated according to the abrasion loss levels; each of the disc brakes dynamically sets the braking force according to the different abrasion losses of the brake shoes, thereby implementing the collaborative control of the multi-channel braking system based on the abrasion loss of the brake shoes, and ensuring the consistency in abrasion of multiple brake shoes of the disc brakes.

### BRIEF DESCRIPTION OF DRAWINGS

FIG. 1 illustrates a flowchart of a method for distributing a braking force of a multi-channel braking system of a mine hoist.

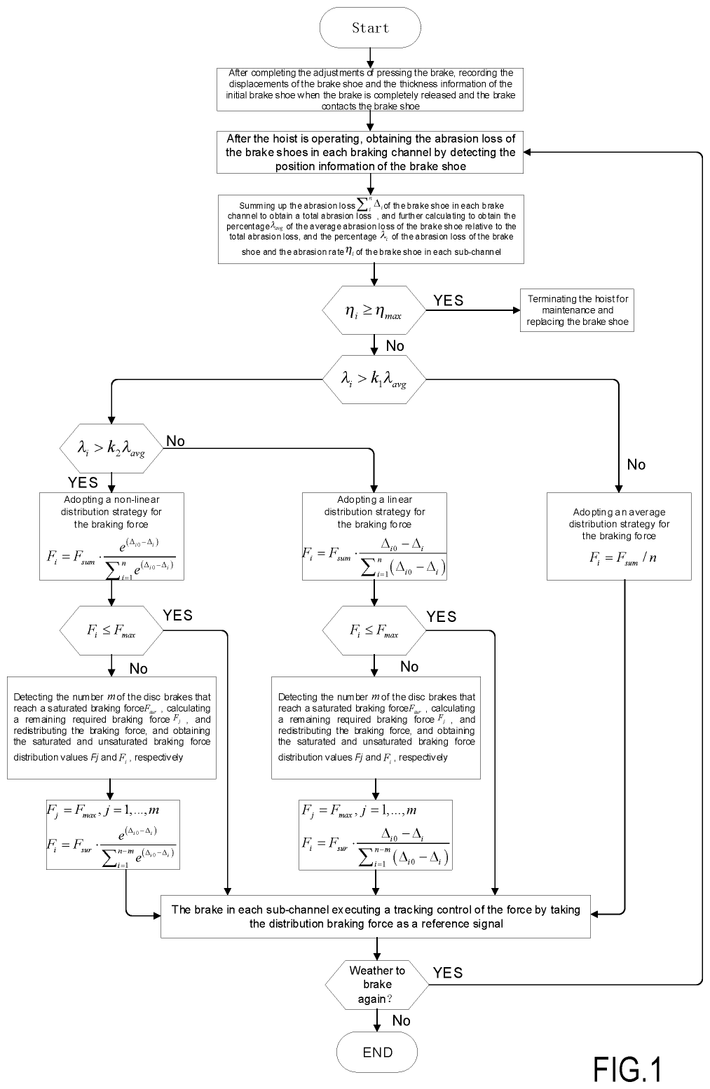

FIG. 2 illustrates a schematic diagram of the multi-channel braking system of the mine hoist.

FIG. 3 illustrates a schematic diagram of a braking force distribution control for the multi-channel braking system of the mine hoist.

In drawings, 1. Drum; 2. Brake disc; 3. Disc brake; 4. Three-position and four-way proportional control valve: 5. Oil pressure sensor; 6. Displacement sensor.

### DESCRIPTION OF EMBODIMENTS

The present disclosure will be further described in detail below in combination with the drawings and the specific embodiments.

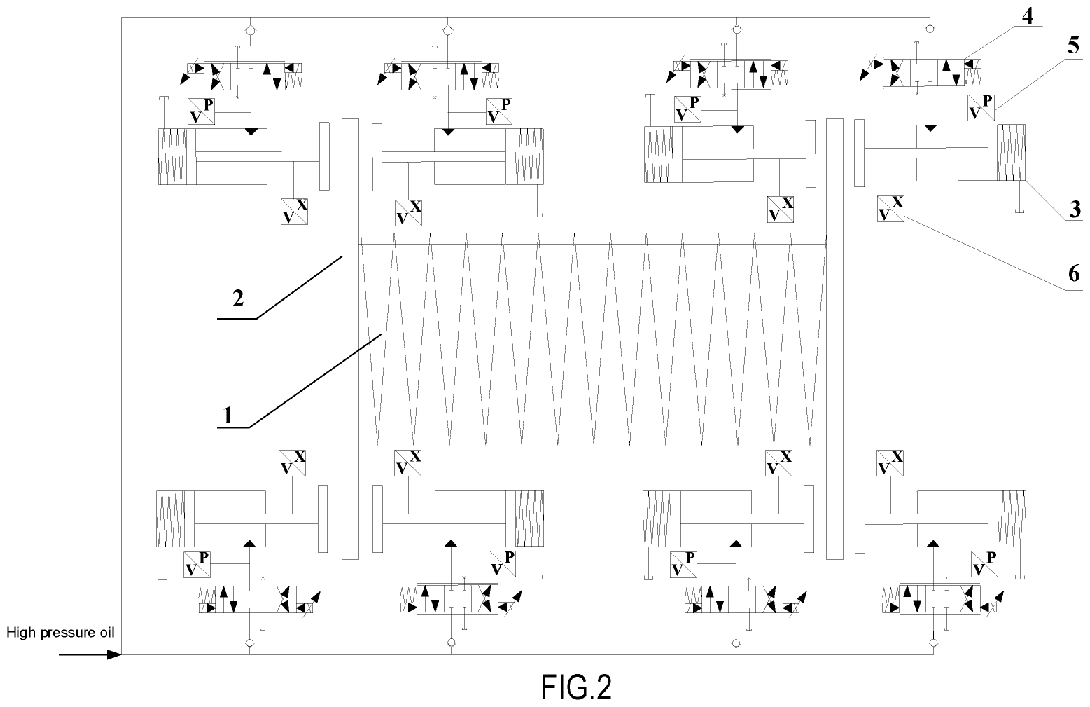

Provided is a method for collaboratively controlling a multi-channel braking system of a mine hoist, and the control method is based on the multi-channel braking system. As illustrated in FIG. 2, brake discs 2 are arranged on both sides of drum 1. Eight disc brakes 3 are symmetrically arranged on both sides of the drum 2. The oil inlet and outlet chambers of each of the disc brakes 3 are connected to a three-position and four-way proportional directional valve 4 through hydraulic pipelines and the eight three-position and four-way proportional directional valves 4 are independently connected to the hydraulic pump station. In order to prevent the disc brake from acting caused by hydraulic oil entering and exiting the brake due to the zero deviation of the directional valve, a center position of a valve core of the three-position and four-way proportional control valve adopted by the present disclosure is a fully covered structure. In addition, a hydraulic sensor 5 is arranged on the oil inlet and outlet chambers of each of the disc brakes 3, and a displacement sensor 6 is arranged on one side proximity to the brake disc 2.

The control method includes the following steps.

In Step S1, the initial position information xᵢₛ₀ of the brake shoe in the case where each of the disc brakes is completely released and the initial position information x_{iy0} of the brake shoe in the case where each of the disc brakes is completely compressed and an initial thickness Δᵢ₀ of the brake shoe when the brake shoe is not braked are measured respectively by utilizing a displacement sensor that arranged on the disc brake 3. And i denotes an i-th disc brake.

In Step S2, the position information xᵢₛ of the brake shoe when the disc brake is completely released is recorded by utilizing the displacement sensor 6 that is arranged on the disc brake before the braking command is issued, in the case where the hoist system is officially put into use. Similarly, the position information x_{iy} of the brake shoe when the disc brake is fully compressed is recorded by utilizing the displacement sensor 6 that is arranged on the disc brake 3 after the braking command is issued, in the case where the hoist system is officially put into use.

In Step S3, an abrasion loss Δᵢ of the brake shoe of the i-th disc brake 3 is calculated according to the measured position information of the disc brake 3, and the calculation formula is Δᵢ=(x_{iy}−xᵢₛ0−(x_{iy0}−xᵢₛ₀). A total abrasion loss of the brake shoe in the multi-channel braking system is Δₛᵤₘ=Σᵢ₌₁ⁿΔᵢ, and the calculation formula is Δₛᵤₘ=Σᵢ₌₁ⁿΔᵢ, where n is the number of the disc brakes 3. The average abrasion loss of the brake shoe is Δ_{avg}, and the calculation formula is Δ_{avg}=Σᵢ₌₁ⁿΔᵢ/n. The percentage λ_{avg} of the average abrasion loss of the brake shoe of the disc brake 3 relative to the total abrasion loss of the brake shoe is calculated according to the physical quantities, and the calculation formula of the percentage λ_{avg} is:

$${λ}_{avg} = \frac{{Δ}_{avg}}{{Δ}_{sum}} = \frac{1}{n} .$$

In Step S4, a percentage λᵢ of an abrasion loss of the brake shoe of the i-th disc brake 3 relative to the total abrasion loss, and an abrasion loss rate ηᵢ of the abrasion loss of the brake shoe of the i-th disc brake relative to the total abrasion loss are calculated, and calculation formulas of the percentage λᵢ and the abrasion loss rate ηᵢ are:

$${λ}_{i} = \frac{{Δ}_{i}}{{Δ}_{sum}} = \frac{( {x}_{iy} - {x}_{is} ) - ( {x}_{iy 0} - {x}_{is 0} )}{{\sum }_{i = 1}^{n} {Δ}_{i}} , \\ {η}_{i} = \frac{{Δ}_{i}}{{Δ}_{i 0}} .$$

In a case where it is indicated that the brake shoe of the disc brake is failed when the abrasion loss rate ηᵢ of the brake shoe of the i-th disc brake 3 is greater than or equal to ηₘₐₓ, the hoist is terminated for maintenance, the brake shoe is replaced, and then Step b) is performed. And ηₘₐₓ denotes a set safety threshold for the abrasion loss rate of the brake shoe. The safety threshold ηₘₐₓ for the abrasion loss rate of the brake shoe ranges from 15% to 25%.

In Step S5, an abrasion loss degree of the brake shoe of the disc brakes 3 is divided into three abrasion loss levels by comparing λᵢ with λ_{avg}. The abrasion loss level is classified as an abrasion loss level I in the case of λᵢ≤k₁λ_{avg}, the abrasion loss level is classified as an abrasion loss level II in the case of k₁λ_{avg}<λᵢ≤k₂λ_{avg}, and the abrasion loss level is classified as an abrasion loss level III in the case of λᵢ≤k₂λ_{avg} (k₁ and k₂ are coefficients for dividing the abrasion loss level of the brake shoes respectively). Three different distributing means are executed on a total required braking force F_{ref} according to different abrasion loss levels of the brake shoe of the disc brakes 3. The coefficients k1 and k2 for dividing the abrasion loss level of the brake shoes range from 1.5 to 2.5 and from 4.5 to 5.5, respectively.

In Step S6, in the case where the abrasion loss level of the brake shoe of the disc brakes 3 is the abrasion loss level I, a total braking force Fₛᵤₘ obeys an equal distribution principle, and a braking force distribution value Fᵢ of the disc brakes is set as:

$${F}_{i} = \frac{{F}_{sum}}{n} .$$

In Step S7, in the case where the abrasion loss level of the brake shoe of the disc brakes 3 is the abrasion loss level II, the total braking force Fₛᵤₘ obeys a proportional distribution principle, and the braking force distribution value Fᵢ of the disc brakes is set as:

$${F}_{i} = {F}_{sum} \cdot \frac{{Δ}_{i 0} - {Δ}_{i}}{{\sum }_{i = 1}^{n} ( {Δ}_{i 0} - {Δ}_{i} )} .$$

Whether to have a situation where the braking force distribution value Fᵢ of the disc brakes 3 is greater than Fₘₐₓ is determined (Fₘₐₓ denotes a maximum braking force that a single disc brake is capable of supplying). It is indicated that the disc brake 3 reaches the maximum braking force that the single disc brake is capable of supplying, that is, the braking force of the disc brake 3 is saturated, when the braking force distribution value Fᵢ of the disc brakes 3 is greater than Fₘₐₓ. The number m of the disc brakes 3 that reach the saturated braking force is detected. For j disc brakes 3 that reach the maximum braking force, a braking force distribution value is set as Fⱼ=Fₘₐₓ,j=1, . . . ,m. A remaining required braking force Fₛᵤᵣ=Fₛᵤₘ−m·Fₘₐₓ is calculated, and a braking force Fₛᵤᵣ is redistributed for n−m disc brakes that do not reach the saturated braking force, and a braking force distribution value Fᵢ of the n−m disc brakes that do not reach the saturated braking force is set as:

$${F}_{i} = {F}_{sur} \cdot \frac{{Δ}_{i 0} - {Δ}_{i}}{{\sum }_{i = 1}^{n - m} ( {Δ}_{i 0} - {Δ}_{i} )} .$$

In Step S8, in the case where the abrasion loss level of the brake shoe of the disc brakes 3 is the abrasion loss level III, the total braking force Fₛᵤₘ obeys an index distribution principle. and the braking force distribution value Fᵢ of the disc brakes 3 is set as:

$${F}_{i} = {F}_{sum} \cdot \frac{{e}^{( {Δ}_{i 0} - {Δ}_{i} )}}{{\sum }_{i}^{n} {e}^{( {Δ}_{i 0} - {Δ}_{i} )}} .$$

Whether to have a situation where the braking force distribution value Fᵢ of the disc brakes 3 is greater than F_{,ax} is determined (Fₘₐₓ denotes a maximum braking force that a single disc brake 3 is capable of supplying). It is indicated that the disc brake 3 reaches the maximum braking force that the single disc brake is capable of supplying, that is, the braking force of the disc brake 3 is saturated, when the braking force distribution value Fᵢ of the disc brakes 3 is greater than Fₘₐₓ. The number m of the disc brakes 3 that reach the saturated braking force is detected. For m disc brakes 3 that reach the maximum braking force, the braking force distribution value is set as Fⱼ=Fₘₐₓ,j=1, . . . ,m. A remaining required braking force Fₛᵤᵣ=Fₛᵤₘ−m·Fₘₐₓ is calculated, and a braking force Fₛᵤᵣ is redistributed for n−m disc brakes 3 that do not reach the saturated braking force, and a braking force distribution value Fᵢ of the n−m disc brakes that do not reach the saturated braking force is set as:

$${F}_{i} = {F}_{sur} \cdot \frac{{e}^{( {Δ}_{i 0} - {Δ}_{i} )}}{{\sum }_{i}^{n - m} {e}^{( {Δ}_{i 0} - {Δ}_{i} )}} .$$

In Step S9, a closed-loop tracking control of the disc brake 3 for the braking force distribution value Fᵢ is implemented driven by the three-position and four-way proportional control valve 4 by utilizing a pressure signal feedback from the oil pressure sensor 5 arranged in the oil inlet and outlet chambers of the disc brake 3, after completing distribution of a braking pressure for the disc brake 3.

In Step S10, a braking task is completed, a dynamic distribution of the braking force is implemented, and Steps S1 to Step S9 are repeated in the case of requiring a subsequent braking operation.

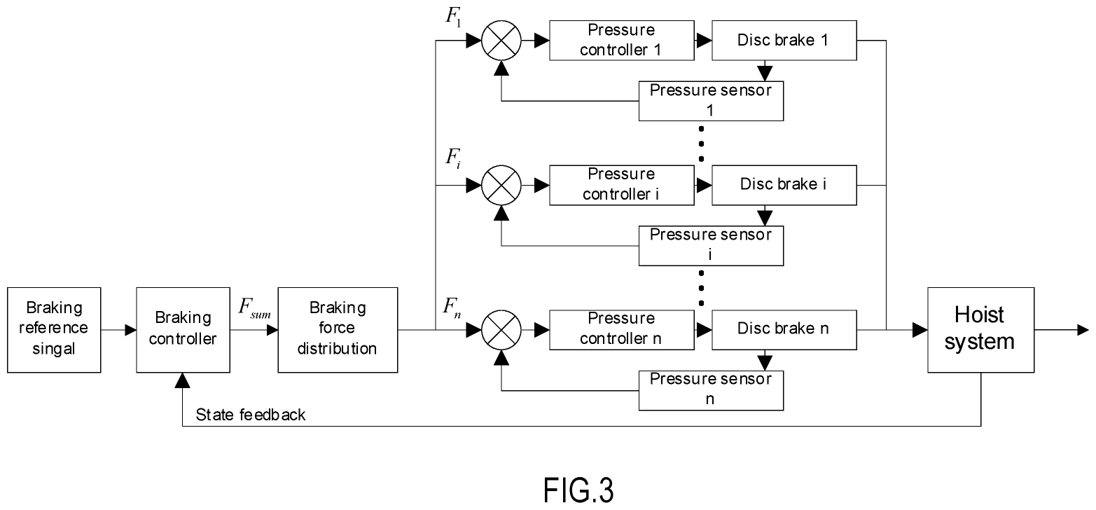

The principle of the collaborative control structure of the multi-channel braking system of the mine hoist is as illustrated in FIG. 3. The total braking force Fₛᵤₘ is calculated by the braking controller, by utilizing the feedback of the hoist system states under setting hoist braking reference signals. Then, the braking force distribution value Fᵢ is obtained by utilizing Step S1 to Step S9, and finally, by utilizing the three-position and four-way proportional control valve and the oil pressure sensor, a closed-loop tracking control of the braking force distribution value of the disc brake is completed, eventually, the collaborative braking control of the multi-channel braking system is implemented.

The embodiments of the present disclosure are described in detail above in conjunction with the accompanying drawings, but the present disclosure is not limited thereto. Without departing from the spirit of the present disclosure, various changes can be made by a person skilled in the art, those all within the protection scope of the claims of the present disclosure.

1. A method for collaboratively controlling a multi-channel braking system of a mine hoist, wherein the control method is based on the multi-channel braking system, the multi-channel braking system comprises a plurality of disc brakes, each of the disc brakes is controlled by an independent proportional control valve, and an oil pressure sensor and a displacement sensor are arranged on each of the disc brakes, and the control method includes following steps:
Step S1, respectively measuring, by utilizing the displacement sensor, initial position information xᵢₛ₀ and x_{iy0} of a brake shoe as well as an initial thickness Δᵢ₀ of the brake shoe in a case where each of the disc brakes is completely released and compressed, where i denotes an i-th disc brake;
Step S2, recording, by utilizing the displacement sensor, a position xᵢₛ of the brake shoe when the disc brake is completely released before a braking command is issued, and a position x_{iy} of the brake shoe when the disc brake is fully compressed after the braking command is issued, in a case where a hoist system is officially put into use;
Step S3, calculating, according to the measured position information of the disc brake, an abrasion loss Δᵢ of the brake shoe, and a total abrasion loss Δₛᵤₘ=Σᵢ₌₁ⁿΔᵢ of the brake shoe in the braking system, where n denotes a number of the disc brakes and an average abrasion loss of the brake shoe is denoted as Δ_{avg}=Σᵢ₌₁ⁿΔᵢ/n, calculating, according to the physical quantities, a percentage λ_{avg} of the average abrasion loss of the brake shoe relative to the total abrasion loss of the brake shoe, and a calculation formula of the percentage λ_{avg} being:
$${λ}_{avg} = \frac{{Δ}_{avg}}{{Δ}_{sum}} = \frac{1}{n} ,$$
Step S4, calculating a percentage λᵢ of an abrasion loss of the brake shoe of the i-th disc brake relative to the total abrasion loss, and an abrasion loss rate ηᵢ of the brake shoe of the i-th disc brake, and calculation formulas of the percentage λᵢ and the abrasion loss rate ηᵢ being:
$${λ}_{i} = \frac{{Δ}_{i}}{{Δ}_{sum}} = \frac{( {x}_{iy} - {x}_{is} ) - ( {x}_{iy 0} - {x}_{is 0} )}{{\sum }_{i = 1}^{n} {Δ}_{i}} , \\ {η}_{i} = \frac{{Δ}_{i}}{{Δ}_{i 0}} ;$$
Step S5, dividing, by comparing λᵢ with λ_{org}, an abrasion loss degree of the brake shoe of the disc brakes into three abrasion loss levels; classifying, in a case of λᵢ≤k₁λ_{org}, as an abrasion loss level I, classifying, in a case of k₁λ_{org}<λᵢ≤k₂λ_{org}, as an abrasion loss level II, and classifying, in a case of λᵢ>k₂λ_{org}, as an abrasion loss level III; executing, according to different abrasion loss levels of the brake shoe of the disc brakes, three different distributing means on a total required braking force F_{ref}, where k₁ and k₂ denote coefficients for dividing the abrasion loss level of the brake shoes respectively;
Step S6, a total braking force Fₛᵤₘ obeying an equal distribution principle, setting a braking force distribution value Fᵢ of the disc brakes as
$${F}_{i} = \frac{{F}_{sum}}{n} ,$$
in a case where the abrasion loss level of the brake shoe of the disc brakes is the abrasion loss level I;
Step S7, the total braking force Fₛᵤₘ obeying a proportional distribution principle, setting the braking force distribution value Fᵢ of the disc brakes as
$${F}_{i} = {F}_{sum} \cdot \frac{{Δ}_{i 0} - {Δ}_{i}}{{\sum }_{i = 1}^{n} ( {Δ}_{i 0} - {Δ}_{i} )} ,$$
in a case where the abrasion loss level of the brake shoe of the disc brakes is the abrasion loss level II;
Step S8, the total braking force Fₛᵤₘ obeying an index distribution principle, and setting the braking force distribution value Fᵢ of the disc brakes as
$${F}_{i} = {F}_{sum} \cdot \frac{{e}^{( {Δ}_{i 0} - {Δ}_{i} )}}{{\sum }_{i}^{n} {e}^{( {Δ}_{i 0} - {Δ}_{i} )}} ,$$
in a case where the abrasion loss level of the brake shoe of the disc brakes is the abrasion loss level III;
Step S9, implementing, by utilizing a pressure signal feedback from the oil pressure sensor arranged on an oil inlet chamber of the disc brake, a closed-loop tracking control of the disc brake for the braking force distribution value Fᵢ driven by a proportional directional valve, after completing a distribution of a braking pressure for the disc brake; and
Step S10, completing a braking task, implementing a dynamic distribution of the braking force, and repeating Step S1 to Step S9 in a case of requiring a subsequent braking operation.

2. The method for collaboratively controlling the multi-channel braking system of the mine hoist according to claim 1, wherein in Step S7, determining whether to have a situation where the braking force distribution value Fᵢ of the disc brakes is greater than Fₘₐₓ, where Fₘₐₓ denotes a maximum braking force that a single disc brake is capable of supplying, wherein it is indicated that the disc brake reaches the maximum braking force that the single disc brake is capable of supplying, that is, the braking force of the disc brake is saturated, when the braking force distribution value Fᵢ of the disc brakes is greater than Fₘₐₓ; detecting a number m of the disc brakes that reach the saturated braking force, setting, for j disc brakes that reach the maximum braking force, a braking force distribution value as Fⱼ=Fₘₐₓ, j=1, . . . ,m; calculating a remaining required braking force Fₛᵤᵣ=Fₛᵤₘ−m·Fₘₐₓ, and redistributing, for n−m disc brakes that do not reach the saturated braking force, a braking force Fₛᵤᵣ, and setting a braking force distribution value Fᵢ of the n−m disc brakes that do not reach the saturated braking force as:
$${F}_{i} = {F}_{sur} \cdot \frac{{Δ}_{i 0} - {Δ}_{i}}{{\sum }_{i = 1}^{n - m} ( {Δ}_{i 0} - {Δ}_{i} )} .$$

3. The method for collaboratively controlling the multi-channel braking system of the mine hoist according to claim 1, wherein in Step S8, determining whether to have a situation where the braking force distribution value Fᵢ of the disc brakes is greater than Fₘₐₓ, wherein it is indicated that the disc brake reaches the maximum braking force that the single disc brake is capable of supplying, that is, the braking force of the disc brake is saturated, when the braking force distribution value Fᵢ of the disc brakes is greater than Fₘₐₓ; detecting a number m of the disc brakes that reach the saturated braking force, setting, for m disc brakes that reach the maximum braking force, a braking force distribution value as Fⱼ=Fₘₐₓ, j=1, . . . ,m; calculating a remaining required braking force Fₛᵤᵣ=Fₛᵤₘ−m·Fₘₐₓ, and redistributing, for n−m disc brakes that do not reach the saturated braking force, a braking force Fₛᵤᵣ, and setting a braking force distribution value Fᵢ of the n−m disc brakes that do not reach the saturated braking force as:
$${F}_{i} = {F}_{sur} \cdot \frac{{e}^{( {Δ}_{i 0} - {Δ}_{i} )}}{{\sum }_{i}^{n - m} {e}^{( {Δ}_{i 0} - {Δ}_{i} )}} .$$

4. The method for collaboratively controlling the multi-channel braking system of the mine hoist according to claim 1, wherein terminating, in a situation where it is indicated that the brake shoe of the disc brake is failed when the abrasion loss rate ηᵢ of the brake shoe of the i-th disc brake is greater than or equal to ηₘₐₓ, the hoist for maintenance, replacing the brake shoe, and then performing Step S2, where ηₘₐₓ denotes a set safety threshold for the abrasion loss rate of the brake shoe.

5. The method for collaboratively controlling the multi-channel braking system of the mine hoist according to claim 4, wherein the safety threshold ηₘₐₓ for the abrasion loss rate of the brake shoe ranges from 15% to 25%.

6. The method for collaboratively controlling the multi-channel braking system of the mine hoist according to claim 1, wherein the coefficients k1 and k2 for dividing the abrasion loss level of the brake shoes range from 1.5 to 2.5 and from 4.5 to 5.5, respectively.

7. The method for collaboratively controlling the multi-channel braking system of the mine hoist according to claim 1, wherein the proportional control valve is a three-position and four-way proportional control valve.

8. The method for collaboratively controlling the multi-channel braking system of the mine hoist according to claim 7, wherein a center position of a valve core of the three-position and four-way proportional control valve is a fully covered structure.

9. The method for collaboratively controlling the multi-channel braking system of the mine hoist according to claim 1, wherein the multi-channel braking system includes eight channels, one disc brake is arranged on each of the channels, and eight disc brakes are symmetrically distributed on both sides of a brake disc.
